(19) United States
(12) Patent Application Publication
(10) Pub. No.: US 2007/0048468 A1
(43) Pub. Date: Mar. 1, 2007

(54) Decorative glazing panels and methods of manufacturing the same

(75) Inventors: Stephen Edwin Howes, Pompano Beach, FL (US); Phillip Tomothy Popple, Kent (GB)

Correspondence Address: BLANK ROME LLP, 600 NEW HAMPSHIRE AVENUE, N.W., WASHINGTON, DC, 20037, US

(73) Assignee: Glasslam Europe Ltd, Sheerness (GB)

(21) Appl. No.: 11/211,704

(22) Filed: Aug. 26, 2005

(51) Int. Cl. E06B 3/00

(52) U.S. Cl. 428/34; 428/138

(57) ABSTRACT

A glazing panel having a decorative pattern comprises a laminar insert of plastics material deformed to replicate a desired decorative pattern positioned between two opposed sheets of glass or other transparent glazing material. The deformed laminar insert has areas which lie in contact with one of the glazing sheets and areas spaced from that sheet and the other glazing sheet of the panel. The areas of the laminar insert in contact with the glazing sheet are bonded to the glazing sheet using a resin which retains a degree of flexibility when set. The spaces defined between the laminar insert and the glazing sheet are entirely filled with a hardenable resin material.

The present invention relates to decorative glazing panels such as windows and mirrors and to methods of manufacturing the same.

Traditionally, decorative windows and mirrors have been fabricated by grinding contours into suitably dimensioned plate glass. Once contoured, the glass is polished to produce the required finish. Windows and mirrors produced in this way are relatively expensive because of the time and skilled labour employed in their manufacture. Decorative windows and mirrors have also been made as composites by adhering or otherwise securing a decorative pane or border to one or more glass sheets. The main disadvantage of windows and mirrors manufactured in this manner is again the relatively high cost incurred during manufacture.

Recent advances have been made to produce decorative windows and mirrors that may be mass produced less expensively than traditional methods. For example, windows and mirrors with decorative designs and surfaces have been produced by injection moulding techniques using clear thermoplastic materials. However, if various sizes, shapes, and patterns of windows are desired, then such techniques become expensive due to the high cost of tooling. Limited production runs are also cost prohibitive because a new die must be used for each different size and design. Additionally, such windows have not met with commercial success inter alia because they do not look and feel like glass.

UK Patent Application 2338681A discloses a method of producing a decorative window which overcomes many of the problems discussed above. In this process a glass master containing a decorative pattern is used to fabricate a mould with a complementary pattern. The mould is then oriented against a glass sheet having a release material facing the mould cavity. Hard casting resin is introduced into the cavity and cured. The decorative resin sheet can easily be removed from the mould and used to fabricate a window. The resin sheet can be cut to a desired size and shape. The cured decorative resin sheet is typically laminated to a glass sheet using a soft resin thus forming a decorative window. A second glass sheet may be attached to the decorative window in such a way as to house the resin sheet thus forming a window having an exterior consisting entirely of glass.

U.S. Pat. No. 6,250,027 discloses a double glazing structure in which a flexible laminar glazing insert moulded to replicate a desired decorative pattern is positioned between two glazing panels of the structure. The laminar insert is retained in position between the two panels by convention spacer bars and the spaces between the moulded laminar insert and the glazing panels is air filled. In use, it has been found that the presence of spacing bars is insufficient to retain the insert in place and that, accordingly distortion can occur due inter alia to changes in climactic conditions.

The present invention sets out to provide an alternative decorative glazing panel to that disclosed in UK-A-2338681A and one which does not suffer from, or at least alleviates, many of the disadvantages discussed above in relation to U.S. Pat. No. 6,250,027.

In one aspect the invention provides a glazing panel having a decorative pattern, the panel comprising a laminar insert of plastics material deformed to replicate a desired decorative pattern positioned between two opposed sheets of glass or other transparent glazing material, the deformed laminar insert having areas which lie in contact with one of the glazing sheets and areas spaced from that sheet and the other glazing sheet of the panel, the areas of the Iaminar insert in contact with the glazing sheet being bonded thereto with a resin which retains a degree of flexibility when set, and the spaces defined between the laminar insert and the glazing sheet being entirely filled with a hardenable resin material.

The laminar insert may be transparent, translucent, coloured or partially coloured. The laminar Insert is preferably produced from a polyethylene terephthalate (PET) plastics material and may be deformed using a vacuum forming process.

The resin which bonds the laminar insert to the glazing sheet is preferably a polyurethane resin or a polyester resin, typically it comprises a urethane polymer blend as manufactured and marketed by NGI Inc, Florida, USA.

A colour may be applied to the deformed laminar insert by, for example, a screen printing operation.

Hardenable liquid resin may be cast into the spaces defined between the opposed surfaces of the laminar insert and the glazing sheet through openings formed in the insert. Casting may be under pressure to ensure that all air is removed from the spaces.

In another aspect, the invention provides a decorative window which comprises two sheets of glass or equivalent transparent glazing material between which is positioned a flexible insert of PET plastics deformed to replicate a required decorative pattern, the insert being bonded to one of the glazing sheets by a resin which is relatively flexible when set and the spaces between the insert and the glazing sheet to which it is bonded being filled with a clear hardenable resin material.

In another aspect, the invention provides a method of producing a double glazed panel having a decorative pattern, the method comprising the steps of deforming by a vacuum forming or like process a sheet of flexible plastics material to produce an insert having a desired pattern, positioning the deformed insert between two generally parallel and spaced apart sheets of glass or other transparent glazing material, bonding the deformed sheet to one of the glazing sheets using a resin which retains a degree of flexibility when set, filling by casting the spaces between the laminar insert and the glazing sheet with liquid hardenable resin, allowing the resin to harden, positioning the other glazing sheet on spacers supported on the glazing sheet to which the insert is bonded whereby the glazing sheets are separated by a distance greater than the height of the deformed inserts above the glazing sheet to which it is bonded, and securing the glazing sheets together to form the glazed panel.

The cast resin may comprise a mix of a silane and a catalyst, the mixture being exposed to a vacuum before casting to remove any trapped air therefrom.

The invention will now be described by way of example only with reference to the accompanying diagrammatic drawings in which:—

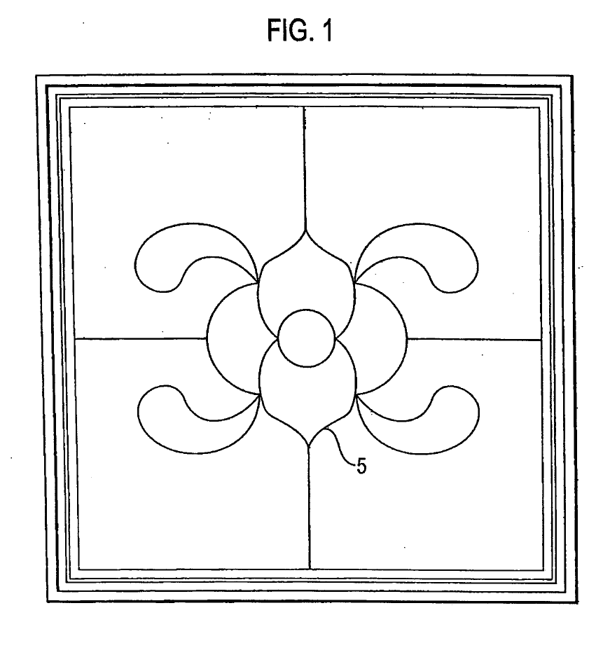

FIG. 1 is a plan view of a glazing panel in accordance with the invention; and

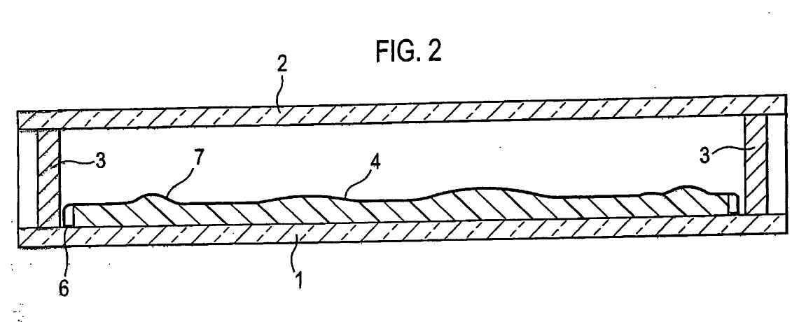

FIG. 2 is a cross-section taken along line II-II of FIG. 1.

The panel illustrated In the drawings is double glazed and comprises two sheets of toughened glass 1, 2, separated by spacers 3 which bear against opposed surfaces of the glass sheets, 1, 2. Positioned between the glass sheets is a deformed laminar insert 4 of PET plastics. The laminar insert is produced by subjecting a plain sheet of PET plastics to a vacuum forming process to produce in the laminar insert a decorative pattern which may, for example, replicate the style of a cut glass glazed panel. A typical pattern 5 can be seen from FIG. 1. When deformed, the laminar insert has areas 6 in contact with the inner face of the glass sheet 1 and areas 7 spaced from the sheet. The surface of the laminar insert remote from the glass sheet 1 is spaced from the inner face of the glass sheet 2.

As shown, the areas 6 are positioned at the perimeter of the insert. These areas may, therefore, define a continuous lip about the insert. In an alternative embodiment, discrete areas of the insert within the perimeter may also lie in contact with the glass sheet 1.

The contacting areas of the laminar insert are bonded to the glass sheet 1 with a polyurethane-containing resin typically a urethane polymer blend as manufactured by NGI Inc, Florida, USA. The entire perimeter of the laminar insert is bonded in this way to the glass sheet together with any other contacting areas.

The urethane polymer resin used for this bonding process retains a degree of flexibility when set to enable movement to occur between the laminar insert and the glass sheet caused by, for example, variations in temperature. It will be seen that the areas 6 of the laminar insert do not lie in contact with any part of the glazing sheet.

The areas defined between the opposed surfaces of the laminar insert and the glass sheet 1 are filled with a transparent or translucent hardenable resin material.

The laminar insert may extend over the entire area of the glass sheet 1 or over only one or more discrete sections thereof.

To produce the panel illustrated in FIG. 1, the laminar PET sheet is first deformed using for example a vacuum-forming process to produce the insert having the desired pattern. The deformed laminar insert is then bonded to one surface of the glass sheet 1 using the urethane polymer bonding resin. Once bonded, the spacer between the opposed surfaces of the glass sheet 1 and the flexible laminar insert 4 are filled with a hardenable liquid resin. The liquid resin is cast under pressurised conditions into the spaces via discrete openings formed in the surface of the laminar insert. Pressurisation may be required to remove all air from the spaces as the casting process proceeds. The resin is then allowed to set, possibly with the assistance of applied heat.

The spacers 3 are then secured to the inner face of the glass sheet 1 and the glass sheet 2 is then supported and secured to the spacers. Finally, the area between the spacers and the opposed surfaces of the glass sheets is filled with a suitable sealant.

If a coloured effect is required, this can be achieved by screen printing a coloured pattern to the PET laminar insert before it is bonded to the glass sheet 1.

It will be appreciated that the foregoing is merely exemplary of glazing panels in accordance with the invention and methods of their production and that various modifications can readily be made to the scribed panel and method without departing from the scope of the invention disclosed.

1. A glazing panel having a decorative pattern, the panel comprising a laminar insert of plastics material deformed to replicate a desired decorative pattern positioned between two opposed sheets of glass or other transparent glazing material, the deformed laminar insert having areas which lie in contact with one of the glazing sheets and areas spaced from that sheet and the other glazing sheet of the panel, the areas of the laminar insert in contact with the glazing sheet being bonded thereto with a resin which retains a degree of flexibility when set, and the spaces defined between the laminar insert and the glazing sheet being entirely filled with a hardenable resin material.

2. A panel as claimed in claim 1 wherein the laminar insert is transparent.

3. A panel as claimed in claim 1 wherein the laminar insert is translucent.

4. A panel as claimed in claim 1 wherein the laminar insert is coloured or partially coloured.

5. A panel as claimed in claim 1 wherein the laminar insert is produced from a polyethylene terephthalate (PET) plastics material.

6. A panel as claimed in claim 5 wherein the insert is deformed using a vacuum forming process.

7. A panel as claimed in claim 1 wherein the resin which bonds the laminar insert to the glazing sheet is a polyurethane resin or a polyester resin.

8. A panel as claimed in claim 7 wherein the resin comprises a urethane polymer.

9. A panel as claimed in claim 1 wherein a colour is applied to the deformed laminar.

10. A panel as claimed in claim 9 wherein the colour is applied by a screen printing operation.

11. A panel as claimed in claim 1 wherein hardenable liquid resin is cast into the spaces defined between the opposed surfaces of the laminar insert and the glazing sheet through openings formed in the insert.

12. A panel as claimed in claim 11 wherein casting is under pressure sufficient to ensure that all air is removed from the spaces.

13. A decorative window which comprises two sheets of glass or equivalent transparent glazing material between which is positioned a flexible insert of PET plastics deformed to replicate a required decorative pattern, the insert being bonded to one of the glazing sheets by a resin which is relatively flexible when set and the spaces between the insert and the glazing sheet to which it is bonded being filled with a clear hardenable resin material.

14. A method of producing a double glazed panel having a decorative pattern, the method comprising the steps of deforming by a vacuum forming or like process a sheet of flexible plastics material to produce an insert having a desired pattern, positioning the deformed insert between two generally parallel and spaced apart sheets of glass or other transparent glazing material, bonding the deformed sheet to one of the glazing sheets using a resin which retains a degree of flexibility when set, filling by casting the spaces between the laminar insert and the glazing sheet with liquid hardenable resin, allowing the resin to harden, positioning the other glazing sheet on spacers supported on the glazing sheet to which the insert is bonded whereby the glazing sheets are separated by a distance greater than the height of the deformed inserts above the glazing sheet to which it is bonded, arid securing the glazing sheets together to form the glazed panel.

15. A method as claimed in claim 14 wherein the cast resin comprises a mix of a silane and a catalyst, the mixture being exposed to a vacuum before casting to remove any trapped air therefrom.

16. A glazing panel substantially as herein described and as described with reference to the accompanying diagrammatic drawings.
